(19) United States
(12) Patent Application Publication
(10) Pub. No.: US 2008/0183344 A1
(43) Pub. Date: Jul. 31, 2008

(54) Systems and methods for communicating restricted area alerts

(75) Inventors: William G. Doyen, Annapolis, MD (US); William B. Pemberton, Baltimore, MD (US); Timothy L. Hinson, Annapolis, MD (US)

Correspondence Address: OLIFF & BERRIDGE, PLC, P.O. BOX 320850, ALEXANDRIA, VA, 22320-4850, US

(73) Assignee: ARINC INC., ANNAPOLIS, MD (US)

(21) Appl. No.: 11/699,353

(22) Filed: Jan. 30, 2007

(51) Int. Cl. G01C 21/00; G05D 1/08

(52) U.S. Cl. 701/9; 701/207

(57) ABSTRACT

A method and system are provided for generating a restricted area alert. As a vehicle nears geographic location(s) through which traffic is restricted, sensor(s) detect the geographic position of the vehicle, and compare that geographic position with information regarding known restricted areas. Upon actual or anticipated entry of the vehicle into the restricted area, an alert message will be generated, formatted and transmitted to the vehicle, and/or additional recipients.

### BACKGROUND

This disclosure is directed to systems and methods of notifying a vehicle operator of potential or actual entry into a restricted area.

In recent years, security concerns have significantly increased worldwide. As these security concerns increase, specific measures are implemented to address specific threat scenarios that individuals or groups may encounter. Among these security measures, increasingly temporary restrictions to or through a specific geographic location are employed to reduce the risk to individuals, groups, and/or specific activities. When such measures are implemented to restrict, for example, ground-based vehicular traffic and/or foot traffic, barriers may be erected, or law enforcement officials may be deployed, to specifically block, interdict or otherwise impede traffic to or through a specific area. Reasons for imposing such restrictions may include, for example, areas where dignitaries may be traveling and/or assembling that may prove particularly susceptible to external threats if traffic to and through such area is not restricted.

This scenario becomes particularly acute regarding aerial traffic over such a geographic location. The increased security concern, and other related concerns that have been exhibited in recent times, have seen a significant increase in the Federal Aviation Administration and/or other governmental agencies use of Temporary Flight Restrictions (TFRs) to designate air space around and above a certain geographic location as a restricted and/or “no-fly” zone. TFRs are illustrative examples only as the restrictions may include both temporary and permanent restrictions. Common examples of employment of TFRs may include, for example, areas through which a specified dignitary's motorcade may be scheduled to travel.

TFRs are announced in Notices to Airmen (NOTAMs) and otherwise. The Federal Aviation Regulations require that, as part of an individual aircrew's preflight planning routine, the NOTAMs regarding areas to and/or through which an expected route of flight will proceed must be reviewed.

TFRs define, for example, by a plurality of geographic reference points, a geometrically shaped area on the surface, the airspace above which must not be penetrated during the times that the TFR is active. All information regarding the location and boundaries of the TFR, any altitude limitations therein, and the period of time for which the TFR will be active is available at least via NOTAM and otherwise via numerous sources.

Penalties for violating a TFR may be severe. Such penalties may include but are not limited to, fines, suspension of licenses, and/or confiscation of an aircraft/vehicle, and potentially the destruction of the aircraft and death of all people onboard.

With the increased implementation of security measures in the aviation community, it is paramount that individual pilots be aware of both their predicted flight path and their actual locations with respect to designated no-fly areas, such as those identified by TFRs. TFRs may be activated on either a short term, or a long term, basis depending on the individual circumstances. For example, a TFR may be designated within the airspace surrounding a large public event, prior to, and during the actual event. It can be anticipated that the implementation of TFRs will only increase, as the need for increased security measures heightens based on world events.

Responsibility for compliance with, and avoidance of, designated TFRs lies on the individual pilot. This burden may become cumbersome in various geographic areas where multiple and frequently changing TFRs may be activated. For example, the airspace surrounding the District of Columbia, can be frequently restricted by a plurality of TFRs at any one time. This burden is significant in that TFRs may be implemented once an aircraft is airborne.

While this problem, as described above, is particularly acute with regard to aircraft, and specifically TFRs, other geographic locations, for example, on land or at sea may be designated as restricted areas as well, either on a temporary or permanent basis. Depending on the size of the area, and the importance attributed to it, policing and/or patrolling of all of the perimeter of such an area may be equally taxing.

### SUMMARY

In view of the above, it would be advantageous to provide systems and methods to notify a pilot of an aircraft or an operator responsible for the guidance of another vehicle (vehicle operator) that either the intended track, or the actual location of the aircraft or vehicle, has, or will, violate one or more restricted areas. Due to the potentially dynamic nature of temporarily-imposed restrictions on travel in specified areas, such as TFR's, vehicle operators and aircraft pilots may mistakenly stray into a restricted area unknowingly, resulting in serious consequences for the vehicle operators or pilots. Providing a vehicle operator or an aircraft pilot with an automated indication that they are about to encounter a restricted area may be advantageous in order to allow the operator or pilot to avoid such an area.

Based on the volume of surface or airborne traffic in any specific geographic location, reliance on, for example, a voice communication from a remote operator monitoring the restricted travel area may not be enough. Man-in-the-loop communication systems in which a monitoring operator communicates a warning individually or collectively to vehicle operators or aircraft that are about to encounter such an area may prove cumbersome and unworkable. As such, it would be advantageous to provide an automated system which, based on discerning a location of a vehicle in proximity to a restricted area may provide an automated warning to the vehicle operator thereby resulting in the operator taking such action as may be required to avoid the restricted area.

In various exemplary embodiments, the systems and methods according to this disclosure may provide a capability to automatically communicate a restricted area policy to vehicles in order that the operators of those vehicles may be alerted to the presence of a restricted area in order to undertake actions to avoid entering, or to quickly egress, such restricted areas.

In various exemplary embodiments, disclosed systems and methods may be particularly well-adapted to providing alert messages to pilots of light commercial and general aviation aircraft, as implementations of systems and methods contemplated to communicate a restricted travel alert policy, such as policy regarding a TFR, are not envisioned to require any modification to conventional communication and/or information systems currently installed in, and employed by, such aircraft. Implementation of a restricted area alert methodology for aircraft to avoid, for example, TFRs, is anticipated to use existing communication means, and any conventional or contemplated means of communication between aircraft and an associated ground station. In exemplary embodiments, one or more functions may be accomplished, completely, or in significant portion, at a location remote from the effective restricted area. These functions include, but are not limited to: (1) data collection and fusion; (2) vehicle tracking; (3) conflict analysis between an actual, or predicted, vehicle position in reference to a boundary of a restricted area; (4) addition of a range buffer outside such boundary based on, for example, a scheme of movement of the vehicle and/or time latency required for system data collection, fusion, analysis and communication; and (5) automated formatting of a message to be communicated to the vehicle based on a determination of a conflict. With regard to implementing such systems and methods for deconflicting aircraft from TFRs, such systems and methods according to this disclosure may be housed in or implemented from one or more ground-based data collection, fusion, analysis and communication centers.

In various exemplary embodiments, disclosed systems and methods may provide a capability for initiating the policy upon the filing of an active flight plan. Once the aircraft is airborne, the published flight plan to include any and all revisions/updates, may be compared against active, and/or scheduled TFRs. The use of flight plans and aircraft is illustrative only as other means of publishing travel routes for a variety of vehicles is anticipated.

In various exemplary embodiments, disclosed systems and methods may provide a capability to alert vehicle operators or aircraft pilots to the presence of, or an impending conflict with, a restricted area. It should be appreciated that restricted area policies may be imposed and communicated to vehicle operators for any of myriad reasons. Restricted areas may, for example, be defined as governmental agency imposed restrictions, locally imposed restrictions, and/or weather related restrictions for which vehicle operators would benefit by being informed of the locations of such defined restricted areas.

In exemplary embodiments, disclosed systems and methods may provide an interactive capability whereby a vehicle operator may be afforded an opportunity to provide certain parameters that the vehicle operator may consider to adversely affect travel in a particular vehicle, such as, for example, adverse weather effects. Specifically, an operator pilot may be afforded the opportunity to predetermine certain weather thresholds based on numerous operating considerations such that, once conditions are either anticipated to, or actually have developed that, exceed the predetermined weather thresholds, the vehicle operator is warned based on the predicted scheme of movement of the vehicle to avoid such area.

In various exemplary embodiments, disclosed systems and methods may use ground-detecting stations for identifying an actual three-dimensional location of an aircraft for comparison to both the published flight plan to include any and all revisions/updates, and active TFRs. Such location identification may consist of GPS downlinks from the aircraft itself, or information provided by radar, or other location-monitoring systems, or otherwise. It is also anticipated that disclosed systems and methods may make use of capabilities onboard the aircraft for determining and reporting the actual three-dimensional location of the aircraft.

In various exemplary embodiments, disclosed systems and methods may, once either the potential for, and/or actual, entry of a vehicle into the restricted travel area is identified, generate an alert message or warning automatically and transmit the alert message or warning to conventional data receivers or communication systems within the vehicle.

In various exemplary embodiments, disclosed systems and methods for automatically generating an alert message or warning to be output to a vehicle may consist of producing, for example, (1) an audible warning tone or communication, (2) a visual data presentation on, for example, a data display or graphical user interface device, or (3) another sensory alerting transmission. It is anticipated that the alert message or warning may also be a textual data message that may be transmitted to any type of, for example, computerized flight log such as a PDA, personal computer, cellular telephone, Electronic Flight Bag or the like.

In various exemplary embodiments, disclosed systems and methods may include provision that the generated message may be customized based on anticipated travel conditions and/or routes. For example, an individual vehicle operator may request notification when approaching a predetermined buffer zone established around the restricted area, such as, for example, when passing within five nautical miles of a restricted area. Additionally, when the system is being employed for weather avoidance, an individual vehicle operator may request identification of specific weather conditions, for example, winds above 35 knots.

In various exemplary embodiments, disclosed systems and methods may include, within the alert message or warning notification to the individual vehicle, an identification of a means by which to contact locally, or remotely, an agency or individual tasked with monitoring, patrolling and/or enforcing the restrictions on travel through the restricted area. In the case of a TFR, this capability is envisioned to include providing a frequency for contacting the restricted airspace controller. Other data may be formatted and communicated to individual vehicle operators. For example, the alert message or warning may include a closest point of exit for the vehicle from a restricted area that the vehicle has already entered.

In various exemplary embodiments, disclosed systems and methods may incorporate approximation algorithms to predict a scheme of movement of a vehicle or an anticipated path of an aircraft to identify potential conflicts with restricted areas.

It should be appreciated again that this disclosure may focus on a concept of restricted airspace alert conducted by a ground station with message notification to individual, or groups of, aircraft, for ease of description, depiction and clarity. By providing a specific example for which employment of disclosed systems and methods may be advantageous, systems and methods according to this disclosure should not be construed as being limited to such implementations. Rather, disclosed systems and methods may find application in any scenario in which automatically alerting the vehicle operator, or any individual, of the proximity of the location of the vehicle, or the individual, to a fixed geographic area, such as a restricted areas or an area of restricted ingress and egress, may prove advantageous.

Further, for the purposes of this disclosure, the term “vehicle” should be considered as being applicable to various alternative modes of travel on the land, in the air and on or under the sea.

These and other features and advantages of disclosed systems and methods are described in, or apparent from, the following detailed description of various exemplary embodiments.

### BRIEF DESCRIPTION OF THE DRAWINGS

Various exemplary embodiments of disclosed systems and methods will be described, in detail, with reference to the following figures, wherein:

FIG. 1 illustrates a flowchart of a method for communicating information regarding a restricted area to an individual or operator of a vehicle according to this disclosure; and

FIG. 2 illustrates a block diagram of an exemplary embodiment of a system for communicating information regarding a restricted area to an individual or operator or other interested parties such as dispatchers or owners of a vehicle according to this disclosure.

### DETAILED DESCRIPTION OF EMBODIMENTS

The following description of various exemplary embodiments of disclosed systems and methods will describe an exemplary system for communicating information regarding a restricted area to an individual or vehicle operator, e.g., a pilot of an aircraft. In the following discussion, specific reference may be made to employing disclosed systems or methods to aid the pilot of an aircraft in avoiding an area over which a Temporary Flight Restriction (TFR) has been imposed. The systems and methods according to this disclosure are not intended to be limited to such applications, as discussed above.

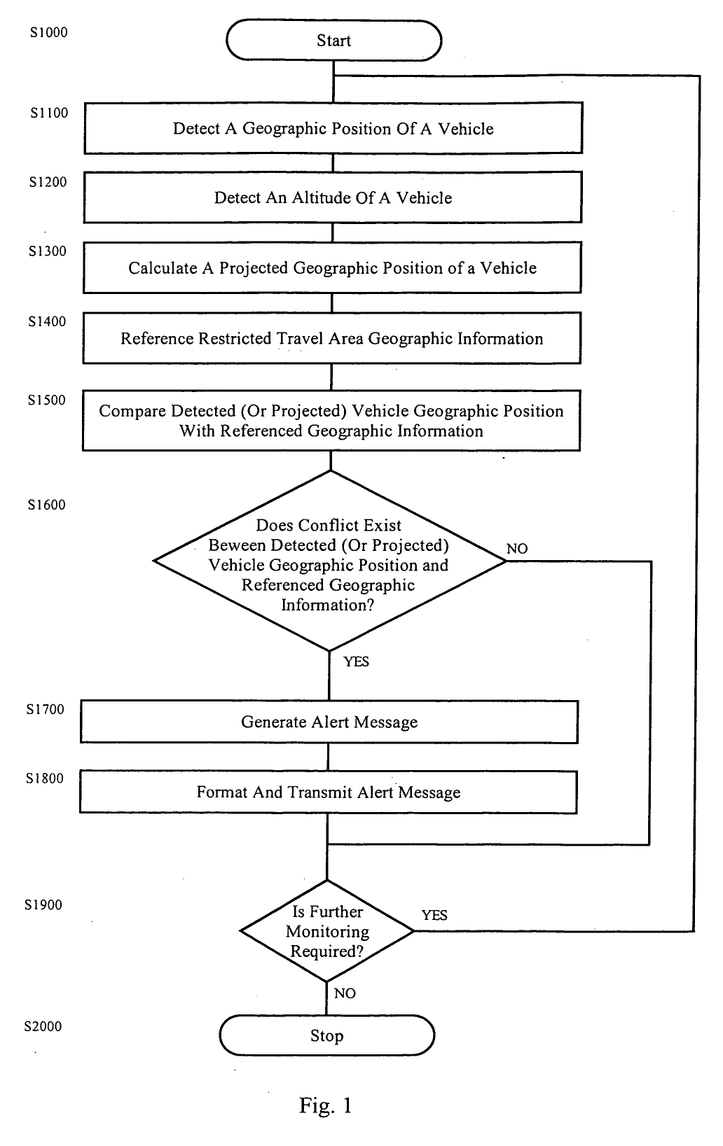

FIG. 1 illustrates a flowchart of a method for communicating information regarding a restricted area to an individual or operator of a vehicle according to this disclosure.

As shown in FIG. 1, operation of the method begins at step S1000 and continues to step S1100 where a geographic position of a vehicle is detected. It should be appreciated that such geographic position may be detected by systems internal to the vehicle such as, for example, global positioning satellite communicating systems capable of localizing a position of a vehicle, and optionally transmitting such position from the vehicle to a remote receiving node. Alternatively, a system for detecting a geographic position of the vehicle may be located remotely from the vehicle such as, for example, a radar system, or other like system that communicates with, for example, a transmitter in the vehicle, such system being capable of localizing the geographic position of the vehicle. Virtually any capability by which a geographic position of a vehicle may be detected and localized, such detected position converted to data usable by vehicle systems or detectable by external systems, are envisioned. Operation of the method continues directly to step S1400, or optionally to one or more of steps S1200 or S1300.

In optional step S1200, particularly in situations where the vehicle is an aerial vehicle, a geographic position of the vehicle may be further determined in three dimensions. For example, an altitude of the vehicle is determined should such information be deemed necessary or appropriate for later comparison to available geographic reference information. Operation of the method continues directly to step S1400 or to optional step S1300.

In optional step S1300, a projected geographic position of a vehicle may be calculated. Such calculation of a projected geographic position may be advantageous in providing a predictive capability for the disclosed method as will be discussed in more detail below. It should be appreciated that the calculation of a projected geographic position of the vehicle may be based on myriad parameters to which the calculating algorithm may be suited. In general, these parameters will be based on a known or predicted scheme of movement of the vehicle. Operation of the method continues to step S1400.

In step S1400, information available on restricted areas may be referenced. Such restricted area information may include, but not be limited to, (1) geographic information for localizing, in two dimensions, an area into or through which vehicular traffic is intended to be restricted; (2) altitude information, for example, above a defined restricted travel area that includes a range of altitudes through which aerial travel is restricted; (3) weather concerns that may define restrictions regarding travel in a particular area; and/or (4) a controlling entity, such as a law enforcement agency, other governnental agency, commercial entity, or private individual, empowered and/or authorized to institute restrictions on traffic through a designated geographic area, such information including, where applicable, contact information for the control entity.

It should be appreciated that geographic reference information may be optionally stored in a database, and where such storage of information has been undertaken, reference to such information may involve accessing the stored database of such information. Operation of the method continues to step S1500.

In step S1500, a comparison is made between detected, or projected, vehicle geographic position, in two or more dimensions to facilitate determining whether conflict exists between the detected or projected vehicle geographic position and an area to or through which travel is restricted. Operation of the method continues to step S1600.

It should be appreciated that an example of such a restricted area may be defined by a temporary flight restriction for aircraft imposed by the Federal Aviation Administration, the Department of Homeland Security, the U.S. Secret Service, other Federal governmental entity, or by local law enforcement or other agency.

In step S1600, a determination is made whether a conflict exists between the detected, or projected, geographic position of the vehicle and the referenced geographic information regarding an area of restricted travel.

If in step S1600 a determination is made that no conflict exists, operation of the method continues to step S1900.

If in step S1600 a determination is made that a conflict exists between the detected, or projected, vehicle position and referenced geographic information regarding at least one restricted area, operation of the method continues to step S1700.

In step S1700, an alert message may be generated to alert a vehicle operator to the conflict based on the comparison and/or determination. Operation of the method continues directly to step S1900 or to optional step S1800.

In optional step S1800, where appropriate, an alert message may be formatted and transmitted to a compatible receiver in the vehicle. Operation of the method continues to step S1900.

It should be appreciated that the alert message may include simply an auditory, visual or other operator sensory alert capability. Alternatively, the alert message may comprise a text message that may be delivered to a compatible receiver in the vehicle via, for example, a data stream. The alert message, regardless of the specific methodology by which it is delivered, may include information regarding the actual geographic position of the conflict, augmented as appropriate, with other information which may be deemed advantageous to the vehicle operator in resolving the conflict such as, for example, a direction of the most direct egress from the restricted area, an indication of a direction by which the vehicle operator may avoid the restricted area and/or contact information for an entity tasked with monitoring the restricted travel area, such contact information intended to assist a vehicle operator in negotiating and/or avoiding the restricted travel area. Additionally, alert messages, in various exemplary embodiments, may be formatted in consideration of the type of vehicle recipient, i.e., a private civilian aircraft message alert, may be formatted differently than a commercial passenger airliner. Alerts, in various exemplary embodiments, may differ based on the situation such as but not limited to heading towards a TFR, nearing a TFR or entering a TFR.

In step S1900, a determination is made whether further monitoring of an actual or projected geographic position of the vehicle is required, or may prove advantageous. If in step S1900 a determination is made that further monitoring would be advantageous, operation of the method reverts to step S1100.

If in step S1900 the determination is made that further monitoring is not required, or would otherwise not prove advantageous, operation of the method continues to step S2000 where operation of the method ceases.

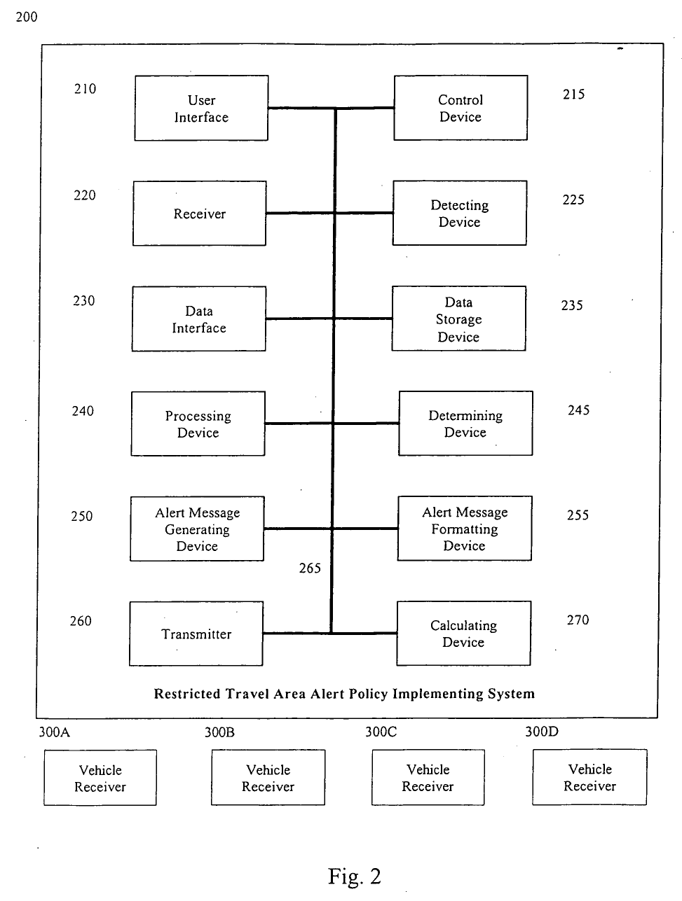

FIG. 2 illustrates a block diagram of an exemplary embodiment of a system for communicating information regarding a restricted area to an individual or vehicle operator according to this disclosure. As shown in FIG. 2, the exemplary system 200 may include a user interface 210, a control device 215, a receiver 220, a detecting device 225, a data interface 230, at least one data storage unit 235, a processing device 240, a determining device 245, an alert message generating device 250, an alert message formatting device 255, a transmitter 260, and a calculating device 270, all connected via a data/control bus 265.

In various exemplary embodiments, one or more vehicle receivers 300A-D may be in communication with the exemplary system 200. Such communication may be undertaken via a compatible transmitter 260 that is capable of transmitting at least one generated alert message from the system 200 to such vehicle receivers 300A-D. Such communication may be formatted via, for example, an alert message formatting device 255 that may provide an alert message in a format compatible with one or more vehicle receivers 300A-D.

In various exemplary embodiments, a user interface 210, when included, may afford a user an opportunity to directly communicate with the system 200. In this manner, information may be input to and/or extracted from the system 200. Otherwise, such user input may be provided to control, modify or update the system 200, or any of the individually identified units and/or devices within the system.

In various exemplary embodiments, elements within, or in communication with, the system 200, may substantially, continuously, or otherwise at discrete intervals, detect a geographic position of one or more vehicles. Such detection may be facilitated by a detecting device 225 that may autonomously be provided information regarding geographic positions of the individual vehicles received via a receiver 220, a data interface 230, or otherwise within the system 200. It should be appreciated that the receiver 220 may be any now known or later developed receiver device that is capable of receiving, for example, wireless communication via RF frequency communication, satellite communication, or otherwise, from one or more vehicles. The data interface 230 may be, for example, employed to integrate information available from other receiving nodes such as, for example, data sources of restricted area data, any remote receiving node that is capable of monitoring via radar, communication or other means, a geographic position of one or more vehicles and providing such information to the system 200 via any manner of wired and/or wireless communication.

It should be appreciated that geographic position information may be computed, determined or otherwise calculated by systems installed in the vehicle, systems co-located with the system 200, or at any intermediate node that may be in communication with, or capable of detecting a position of, an involved vehicle, and otherwise in communication with, for example, the receiver 220, the data interface 230, or the system 200.

It should be further appreciated that such geographic position may be determined in two dimensions, i.e., with reference to any known surface geographic locating system, or system of locating geographic parameters. Additionally, a vertical reference may be included in order that a geographic position is localized in three dimensions where appropriate, i.e., including an altitude of a vehicle above a designated vertical reference. As indicated above, regardless of the content of the geographic position information of the vehicle, processing of such geographic information may occur internal to the vehicle or may occur external to the vehicle and be communicated to the system 200 by virtually any communicative means by which such data may be communicated.

Detected geographic locating information regarding the vehicle, detected by any means as discussed above, may provide an input to a processing device 240. The processing device 240 may use detected geographic locating information for the vehicle, including altitude where appropriate, and reference available information regarding at least one geographic area into which, or through which travel is intended to be restricted, i.e., a restricted travel area. Such determining device 245 may compare the detected geographic position of the vehicle with the referenced information.

The referenced information may include, for example, a plurality of geographic reference points that two-dimensionally define geographic boundaries of the at least one restricted area, a range of altitudes, for example, above at least a portion of the restricted area through which aerial vehicular traffic may be restricted, i.e., as may be defined by a TFR, a control entity that may be empowered or authorized to restrict travel through the restricted area, including contact information for the control entity, and/or weather conditions that may restrict travel through at least one geographic area based on the severity of the weather restrictions themselves, or specific known or user-defined operating thresholds related to an individual vehicle.

The processing device 240 may automatically reference any or all of such reference information available to the system 200 via any one or more of the interfaces, or as may be stored in the at least one data storage device 235. A determining device 245 as a combined device with, or a separate device from, the processing device 240, may then determine that a detected geographic position of one or more vehicles lies within a restricted area. Based then on a determination made in the determining device 245, as a stand alone element from the processing device 240, or in a combined processing/determining device, an alert message may be generated by, for example, an alert message generating device 250. If the alert message generating device 250 is located within the system 200, an alert message formatting device 255 may be available to format a message to be compatible with a known or detected vehicle receiver 300A-D, and the alert message may then be transmitted via any manner of transmitter 260 to such vehicle receivers 300A-D.

It should be appreciated that an ability for an alert message to be presented to at least one vehicle operator in order to alert that operator to a situation in which the vehicle may have entered into, or be about to enter into, an area designated as a restricted area such that the operator can maneuver the vehicle clear of the restricted area in a most expeditious manner is an objective of the systems and methods according to this disclosure. It is for this reason that a generated alert message may include at least one of an indicator of a path to egress or avoid at least one restricted area, and/or contact information for a control entity that is tasked with restricting travel through at least one restricted area.

Calculating device 270 may be available to, for example, calculate a projected geographic position of a vehicle, based on, for example, a predetermined time interval by which an intended movement of the vehicle is projected ahead of the vehicle, or a generic scheme of movement of the vehicle. In such an instance, an alert message may be generated by the alert message generating device 250 to alert a vehicle operator regarding a projected entry into a restricted travel area. Such an alert message being generated based on a calculated projected geographic position of the vehicle may provide a buffer that facilitates a vehicle operator maneuvering the vehicle in response to such an alert message to avoid entry into the restricted area.

As indicated above, restriction of aircraft penetrating areas in which flight restrictions have been imposed is an objective of the systems and methods according to this disclosure, but such systems and methods should not be considered as restricted only to such an application.

It should be further appreciated that although depicted as separate individual elements in, for example, FIG. 2, any of the depicted individual units and/or devices may be combinable with other individual units and/or devices, to combine the capabilities or functions thereof, as combined units and/or devices within the exemplary system 200. Further, while envisioned in an exemplary embodiment that the disclosed system for implementing a restricted area alert policy may be located at a remote data collection, fusion, analysis, control and communication center, elements of the disclosed system may be located within such a center, located within involved vehicles, and/or located at intermediate receiving and/or communication nodes that may be in communication with both the involved vehicles and such a defined center.

Further, while envisioned as individual elements hardwired via an exemplary data/control bus 265, particularly when elements of the system are dispersed, as discussed above, any communication path by which data and/or control inputs may be exchanged between individual units and/or devices, and/or between combination units and/or devices, whether located within involved vehicles, at intermediate nodes, or within a centralized data fusion center, are envisioned. Such involved data communications paths may include individual wired and/or wireless communications connections, or any combination of such connections between communicating elements.

It should also be appreciated that the at least one data storage device 235 may be available to store not only a database containing geographic reference information to be compared to a detected or a projected geographic position of a vehicle, but also may be available to store any manner of system information, system control information, and/or recorded information regarding a system operation and/or data to be input to, or to be output from, the system. Any manner of information which may be made available to a user, or used to evaluate the need to send an alert such as TFR location, or which may facilitate transmission of an alert message to a vehicle may be input to the system via at least one of a user interface 210, a receiver 220, or a data interface 230, or otherwise. Information output from such a system may be output via a user interface 210, a data interface 230, or a transmitter 260, or otherwise. When information is input to the system, it is envisioned that it will be input in a format usable by the system, and when output from the system it is envisioned that such information may be available in a format which is usable by at least a vehicle receiver 300A-D to which such information may be directed.

It should be appreciated that the processing device 240 and the at least one data storage device 235 may provide sufficient data storage and processing capacity to facilitate the inclusion of additional features and/or functionalities to be implemented within the disclosed exemplary system 200. Software applications, for example, to facilitate such other functionalities may be pre-stored within the at least one data storage device 235, or communicated to the exemplary system 200 via the data interface 230 or otherwise.

Any data storage contemplated for various exemplary embodiments of the disclosed system 200 may be implemented using any appropriate combination of alterable or fixed memory. The alterable memory, whether volatile or non-volatile, may be implemented using any one or more of static or dynamic RAM, an internal disk drive with associated disk-type medium, a hard drive, a flash memory or any other like memory medium and/or device. Similarly, fixed memory can be implemented by any one or more of ROM, PROM, EPROM, EEPROM, or compatible disk drive, or any other like memory storage medium and/or device.

It should be appreciated that given the required inputs, the processing outlined above, to be undertaken in either the exemplary system, or as steps in the disclosed exemplary method, may be undertaken by individual system elements, or combinations of system elements, implemented through software algorithms, hardware or firmware circuits, or any combination of software, hardware and/or firmware control and/or processing elements, or otherwise. This is particularly true regarding implementation of the processing for comparison of and/or determination of detected and/or projected geographic positions of, for example, a vehicle, in comparison with referenced geographic information.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The above detailed description of exemplary embodiments of systems and methods for defining a restricted area alert policy is meant to be illustrative, and in no way limiting. The above detailed description of systems and methods is not intended to be exhaustive or to limit this disclosure to any precise embodiments or feature disclosed. Modifications and variations are possible in light of the above teaching. The above embodiments were chosen in order to clearly explain the principles of operation of the systems and methods according to the disclosure and their practical application to enable others skilled in the art to utilize various embodiments, potentially with various modifications, suited to a particular use. Also, various presently unforeseen or unanticipated alternatives, modifications, variations or improvements therein may be subsequently made by those skilled in the art, and are also intended to be encompassed by the following claims.

What is claimed is:

1. A method for implementing a restricted area alert policy, comprising:
detecting a geographic position of a vehicle;
referencing information regarding at least one geographic area in which travel is restricted;
comparing the detected geographic position of the vehicle with the referenced information;
determining that the detected geographic position of the vehicle is within the at least one geographic area in which vehicular travel is restricted; and
automatically generating an alert message to an operator of the vehicle based on the determination.

2. The method of claim 1, wherein at least one of the detecting, referencing, comparing, determining or automatically generating is undertaken with systems external to and remotely located from the vehicle.

3. The method of claim 1, wherein at least one of the detecting, referencing, comparing, determining or automatically generating is undertaken at a remotely located information exchange node.

4. The method of claim 1, wherein detecting the geographic position of the vehicle comprises receiving information regarding the geographic position of the vehicle transmitted from the vehicle.

5. The method of claim 1, wherein the information regarding at least one geographic area in which vehicular travel is restricted comprises a plurality of geographic reference points that two-dimensionally define geographic boundaries of the at least one geographic area in which vehicular travel is restricted.

6. The method of claim 1, wherein the vehicle is an aerial vehicle and the information regarding at least one geographic area in which vehicular travel is restricted includes at least one range of altitudes above at least a portion of the at least one geographic area in which vehicular travel is restricted at which aerial travel above the at least one geographic area is restricted, the method further comprising:
detecting an altitude of the vehicle; and
comparing the detected vehicle altitude with the referenced information.

7. The method of claim 1, further comprising projecting a geographic position of a vehicle when a predetermined time interval is projected to elapse, wherein the comparing and the determining are based on the projected geographic position of the vehicle.

8. The method of claim 4, wherein the predetermined time interval is determined based on a scheme of movement of the vehicle, the predetermined time interval providing a buffer that facilitates a vehicle operator maneuvering the vehicle in response to the alert message to avoid entry into the at least one geographic area in which vehicular travel is restricted.

9. The method of claim 1, wherein the information regarding the at least one geographic area in which vehicular travel is restricted is based on information available from a control entity that restricts travel through the at least one geographic area.

10. The method of claim 9, wherein the control entity is at least one of a law enforcement agency, another governmental organization, a commercial entity or a private individual.

11. The method of claim 1, wherein the at least one geographic area in which vehicular travel is restricted is identified by a Temporary Flight Restriction.

12. The method of claim 1, wherein the information regarding the at least one geographic area in which vehicular travel is restricted is based on information available regarding weather conditions in the at least one geographic area.

13. The method of claim 12, wherein the information regarding the at least one geographic area in which vehicular travel is restricted includes information regarding at least one weather-related threshold for operation of the vehicle.

14. The method of claim 13, wherein the information regarding at least one weather-related threshold for operation of the vehicle is based on at least one of available operating parameters for the vehicle or information received from an operator of the vehicle.

15. The method of claim 1, wherein the alert message is presented to the operator of the vehicle by at least one of an auditory warning tone, a visual alert signal or another sensory input warning device to an operator of the vehicle.

16. The method of claim 1, wherein the alert message is a formatted text message, the method further comprising automatically formatting the alert message and automatically transmitting the alert message to the vehicle.

17. The method of claim 1, wherein the alert message includes an indicator of a path to egress the at least one geographic area in which vehicular travel is restricted.

18. The method of claim 1, wherein the information regarding the at least one geographic area in which vehicular travel is restricted includes contact information for a control entity that restricts travel through the at least one geographic area, and the alert message includes such contact information.

19. The method of claim 1, wherein the information regarding the at least one geographic area in which vehicular travel is restricted is stored in a database that is remotely located from the vehicle, the database being referenced to obtain the information.

20. The method of claim 1, wherein the alert message is automatically generated and transmitted to a location external to the vehicle.

21. A computer-readable storage medium on which is recorded a program for causing a computer to implement the method of claim 1.

22. A system for implementing a restricted travel area alert policy, comprising:
a detecting device that detects a geographic position of a vehicle;
a processing device that references information regarding at least one geographic area in which vehicular travel is restricted and compares the detected geographic position of the vehicle with the referenced information;
a determining device that determines that the detected geographic position of the vehicle is within the at least one geographic area in which vehicular travel is restricted; and
an alert message generating device that automatically generates an alert message to an operator of the vehicle based on the determination made by the determining device.

23. The system of claim 22, wherein at least one of the detecting device, the processing device, the determining device or the alert message generating device are located external to and remotely from the vehicle.

24. The system of claim 22, wherein at least one of the detecting device, the processing device, the determining device or the alert message generating device are located at a remotely-located information exchange node.

25. The method of claim 22, further comprising a receiver that receives information regarding the geographic position of the vehicle transmitted from the vehicle.

26. The system of claim 22, further comprising at least one storage device that stores at least a database of information regarding the at least one geographic area in which vehicular travel is restricted,
wherein the database includes information regarding at least one of:
a plurality of geographic reference points that two-dimensionally define geographic boundaries of the at least one geographic area;
a range of altitudes above at least a portion of the at least one geographic area in which vehicular travel is restricted at which aerial travel above the at least one geographic area is restricted;
a control entity that restricts travel through the at least one geographic area;
contact information for a control entity that restricts travel through the at least one geographic area; or
weather conditions that restrict travel through the at least one geographic area.

27. The system of claim 22, wherein the vehicle is an aerial vehicle, the method further comprising:
detecting an altitude of the vehicle; and
comparing the detected vehicle altitude with the referenced information.

28. The system of claim 22, further comprising a calculating device that calculates a projected geographic position of a vehicle based on a scheme of movement of the vehicle,
wherein the alert message generating device automatically generates the alert message based on the calculated projected geographic position of the vehicle to provide a buffer that facilitates the vehicle operator maneuvering the vehicle in response to the alert message to avoid entry into the at least one geographic area in which vehicular travel is restricted.

29. The system of claim 22, further comprising:
a formatting device for formatting the alert message as a data stream; and
a transmitter for automatically transmitting the alert message to the vehicle,
wherein the alert message further comprises at least one of an indicator of a path to egress the at least one geographic area or contact information for a control entity that restricts travel through the at least one geographic area.

30. The system of claim 22, wherein the at least one geographic area in which vehicular traffic is restricted is identified by a Temporary Flight Restriction.
